(19) United States
(12) Patent Application Publication
(10) Pub. No.: US 2026/0195423 A1
(43) Pub. Date: Jul. 9, 2026

(54) TRACKING METHOD, STORAGE MEDIUM, AND COMPUTER

(71) Applicants: TOYOTA JIDOSHA KABUSHIKI KAISHA, Toyota-shi (JP); THE UNIVERSITY OF TOKYO, Tokyo (JP)

(72) Inventors: Kenjiro TAURA, Tokyo (JP); Takumi HIRAOKA, Tokyo (JP); Shumpei SHIINA, Tokyo (JP); Sho NAKATANI, Tokyo (JP)

(73) Assignees: TOYOTA JIDOSHA KABUSHIKI KAISHA, Toyota-shi (JP); THE UNIVERSITY OF TOKYO, Tokyo (JP)

(21) Appl. No.: 19/423,098

(22) Filed: Dec. 17, 2025

(30) Foreign Application Priority Data
Jan. 7, 2025 (JP) 2025-002037

(51) Int. Cl. G06F 21/10; G06F 21/16

(52) U.S. Cl. CPC G06F 21/1062; G06F 21/16

(57) ABSTRACT

A tracking method according to the present disclosure is a method for tracking sensitivity in differential privacy. The method includes: when a condition is satisfied that each row of a second data frame obtained by applying an operation to one or more first data frames associated with the same first provenance information represents a result of a computation on a corresponding row of the one or more first data frames and the number of rows of the one or more first data frames is the same as the number of rows of the second data frame, associating the second data frame with the first provenance information; when the condition is not satisfied, associating the second data frame with second provenance information different from the first provenance information; and tracking the sensitivity based on an edit distance related to the operation.

### CROSS-REFERENCE TO RELATED APPLICATION

This application claims priority to Japanese Patent Application No. 2025-002037 filed on Jan. 7, 2025. The disclosure of the above-identified application, including the specification, drawings, and claims, is incorporated by reference herein in its entirety.

### BACKGROUND

### 1. Technical Field

The present disclosure relates to tracking methods, storage media, and computers.

### 2. Description of Related Art

C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, describes a method for tracking the sensitivity in differential privacy in a dynamically typed language such as Python.

The product disclosed in “Antigranular” [online], [accessed Dec. 25, 2024], Internet https://www.antigranular.com, includes a system and a library set that ensure the application of differential privacy, and provides an application programming interface (API) for data frames that are similar to pandas DataFrames.

### SUMMARY

Although examples regarding pandas DataFrames, which are ordered data frames, are described in C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, no definition of a distance is provided. In addition, C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, does not consider the tracking of distances in operations between DataFrames.

In “Antigranular” [online], [accessed Dec. 25, 2024], Internet https://www.antigranular.com, the data frames are substantially treated as unordered data structures, and therefore, many operations that require the concept of ordering (e.g., sorting) are not included in the API. In addition, although the sensitivity of individual aggregation operations is defined, there is no functionality to track and compose those sensitivities. Therefore, it is not possible to add perturbation after combining multiple aggregation operations, resulting in limited flexibility.

The present disclosure has been made in view of the above circumstances, and an object thereof is to provide a tracking method, a storage medium, and a computer that are capable of tracking sensitivity for operations on ordered data frames.

A tracking method according to the present disclosure is a method for tracking sensitivity in differential privacy. The method includes: when a condition is satisfied that each row of a second data frame obtained by applying an operation to one or more first data frames associated with the same first provenance information represents the result of a computation on a corresponding row of the one or more first data frames and the number of rows of the one or more first data frames is the same as the number of rows of the second data frame, associating the second data frame with the first provenance information; when the condition is not satisfied, associating the second data frame with second provenance information different from the first provenance information; and tracking the sensitivity based on an edit distance related to the operation.

A storage medium according to the present disclosure stores a program that causes a computer to: when a condition is satisfied that each row of a second data frame obtained by applying an operation to one or more first data frames associated with the same first provenance information represents the result of a computation on a corresponding row of the one or more first data frames and the number of rows of the one or more first data frames is the same as the number of rows of the second data frame, associate the second data frame with the first provenance information; when the condition is not satisfied, associate the second data frame with second provenance information different from the first provenance information; and track sensitivity based on an edit distance related to the operation.

A computer according to the present disclosure is configured to: when a condition is satisfied that each row of a second data frame obtained by applying an operation to one or more first data frames associated with the same first provenance information represents the result of a computation on a corresponding row of the one or more first data frames and the number of rows of the one or more first data frames is the same as the number of rows of the second data frame, associate the second data frame with the first provenance information; when the condition is not satisfied, associate the second data frame with second provenance information different from the first provenance information; and track sensitivity based on an edit distance related to the operation.

The present disclosure can provide a tracking method, a storage medium, and a computer that are capable of tracking sensitivity for operations on ordered data frames.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating the definition of a distance function based on a longest common subsequence (LCS) distance;

FIG. 2 is a diagram illustrating an example of the transition of the distance between private objects; and

FIG. 3 is a diagram illustrating an example of tracking sensitivity for operations between data frames.

### DETAILED DESCRIPTION OF EMBODIMENTS

Hereinafter, specific embodiments to which the present disclosure is applied will be described with reference to the drawings. However, the present disclosure is not limited to the following embodiments. For the sake of clarity, the following description and drawings are simplified as appropriate.

Definitions of the terms used in the following description are provided collectively below.

### Adjacent Databases and Differential Privacy (DP)

Each row in a database corresponds to one individual. The term “adjacent databases” refers to a pair of databases that differs in one row. More precisely, there are the following types of definitions of adjacent databases: Unbounded Differential Privacy (UnboundedDP) in which adjacency is defined based on the presence or absence of a single row, and Bounded Differential Privacy (BoundedDP) in which adjacency is defined based on a change in the value of a single row. UnboundedDP provides a more general definition. Therefore, in the following description, it is assumed that UnboundedDP is used. Differential privacy, particularly ε-differential privacy, is defined by the following expression.

$$\begin{matrix}Expression ( 1 ) & \\ Pr [ 𝒦 ( {D}_{1} ) ∈ S ] \leq exp ( ϵ ) \times Pr [ 𝒦 ( {D}_{2} ) ∈ S ] & ( 1 )\end{matrix}$$

In Expression (1), D₁ and D₂ are adjacent databases. K(D) denotes an operation (e.g., a function or mechanism) that takes a database D as input and returns some output. Expression (1) indicates that the probability that the outputs K(D₁), K(D₂) of an operation K belong to the same output set S differs by at most a factor of exp(ε). If Expression (1) holds for any pair of adjacent databases D₁, D₂, and for any output set S, then the operation K is defined as satisfying ε-differential privacy. Note that ε is a parameter related to the strength of privacy protection and can be set as desired.

### Sensitivity and Distance

To satisfy ε-differential privacy, a probabilistic random perturbation, i.e., noise, is generally added after performing an operation such as an aggregation operation. When the output of the operation is a real number, a perturbation is often added in accordance with a mechanism known as the Laplace mechanism. The Laplace mechanism adds random noise from a Laplace distribution to that real number. It is known that ε-differential privacy can be satisfied by adding random noise from a Laplace distribution L(Δf/ε), which is a probability distribution. Here, Δf is a value referred to as sensitivity, and is defined based on the operation performed before the application of the Laplace mechanism.

$$\begin{matrix}Expression ( 2 ) & \\ Δ f = {max}_{{D}_{1} , {D}_{2}} {‖ f ( {D}_{1} ) - f ( {D}_{2} ) ‖}_{1} & ( 2 )\end{matrix}$$

Expression (2) defines the sensitivity Δf as the maximum absolute difference between f(D₁) and f(D₂), where f(D₁) and f(D₂) are the results of applying an operation to adjacent databases D₁, D₂. Expression (2) indicates that the results of the operation on any pair of adjacent databases D₁, D₂ differ by at most Δf.

In Expression (2), sensitivity is defined for an operation f that takes a database as input and returns a vector of real numbers. The sensitivity for this operation is the final sensitivity used in the application of the Laplace mechanism. However, in practical data processing programs, aggregation operations are often performed on a database by combining multiple operations. In this case, the overall sensitivity is derived by composing the sensitivities individually defined for each operation. When applying the Laplace mechanism, the final sensitivity to be obtained is the sensitivity of a composite function f that takes a database as input and returns a vector of real numbers. Since the input and output types of individual functions may differ from those of the composite function f, a more general definition of sensitivity for functions with arbitrary input and output types is introduced. 15

$$\begin{matrix}Expression ( 3 ) & \\ {d}_{{τ}_{2}} ( f ( x ) , f ( y ) ) \leq c \cdot {d}_{{τ}_{1}} ( x , y ) for all x , y ∈ {τ}_{1} & ( 3 )\end{matrix}$$

Expression (3) defines sensitivity for an operation f that takes an input of an arbitrary type τ₁ and returns an output of an arbitrary type τ₂. Specifically, when the distance between f(x) and f(y) that are the results of applying the operation f to inputs x, y, respectively, is at most c times the distance between the original inputs x, y, then the sensitivity of the operation f is c.

In order to define sensitivity, distance functions specific to the types τ₁, τ₂ are defined. As a specific example, when x and y are real numbers, it is natural to define d(x, y) as |x−y|. In UnboundedDP, when the input is a database, the distance is often defined as the number of elements in the symmetric difference between multisets. In BoundedDP, when the input is a database, the distance is often defined as the Hamming distance. Expression (1) is derived by specializing Expression (3) to the case where the input is a pair of databases at distance 1, namely adjacent databases, and the output is a vector of real numbers. In this way, defining the transition of the maximum value of the distance between input and output forms the basis for tracking distances and sensitivities.

### Tracking of Sensitivity and Distance

As described above, the sensitivity of each individual function can be defined for arbitrary input and output types, and the final sensitivity determined when applying the Laplace mechanism is the sensitivity of a composite function that takes a database as input and returns a vector of real numbers. For simplicity, a case will be described below in which the perturbation is added by the Laplace mechanism and the output of the composite function is a real number. In the present disclosure, the perturbation mechanism is not limited to the Laplace mechanism, and the output of the composite function is not limited to real numbers. The following describes a method for tracking the transitions of the distance defined for each of multiple functions, that is, for composing sensitivities to derive the overall sensitivity of an aggregation operation.

It is herein assumed that the generalized sensitivity described above is defined for each individual operation fi: τ₁→τ₂. A method for determining the sensitivity of the overall operation f: D→R obtained by sequentially composing these individual operations will be described below. For example, when operations f1, f2, and f3 are sequentially applied to a database D and a real number y is obtained as a result, this real number can be expressed as y=f3(f2(f1(D))). Let the sensitivities of f1, f2, and f3 be c1, c2, and c3, respectively. The overall operation is represented by the following composite function f, and the sensitivity of f is given by c1×c2×c3.

$$\begin{matrix}Expression ( 4 ) & \\ f = f 3 ∘ f 2 ∘ f 1 & ( 4 )\end{matrix}$$

That is, starting from adjacent databases, a value obtained by multiplying the sensitivities of the individual operations becomes the sensitivity of the overall operation. A method for composing the sensitivity in more general operations in a programming language is also known. C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, describes a method for tracking sensitivity and composing overall sensitivity in a dynamically typed language such as Python, rather than in a statically typed language.

The basic idea of C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, is to associate distances with values in a programming language and track them. The starting point for sensitivity tracking is a pair of adjacent databases, and program execution begins with an input value of a database type being defined to have a distance of 1. Thereafter, each time an operation is applied to a value, a new distance is associated with the output value of that operation, and the sensitivity or distance is tracked. Provided that the distance associated with a value y is d, when an operation for satisfying differential privacy is ultimately applied to the value y, the sensitivity of the composite function f formed by the sequence of operations applied until y is output can be determined to be d. Thus, ε-differential privacy is satisfied by applying the Laplace mechanism with sensitivity Δf set to d.

Therefore, designing a system that automatically tracks sensitivities and derives the overall sensitivity involves two key aspects: (1) properly defining the sensitivity for each individual operation, and (2) establishing a mechanism for tracking and composing the sensitivities of the individual operations. The present disclosure defines a distance for ordered data frames in order to track and compose the sensitivity of the ordered data frames, and enables the sensitivity of individual operations on the data frames to be defined. The present disclosure can also appropriately compose the sensitivity for complex operations that take multiple data frames as input.

### First Embodiment

### Definition of Distance Between Ordered Data Frames

A computer according to a first embodiment defines a distance between ordered data frames using an edit distance. The computer includes components such as a processor and a memory. The computer may perform processing by executing a program stored in the memory. An edit distance is originally a definition of a distance for character strings. In the first embodiment, the edit distance defined for character strings is generalized, and is used to define the distance of a sequence of personal data, that is, a list of personal data. Although there are multiple types of edit distance, the first embodiment adopts a longest common subsequence (LCS) distance for data frames.

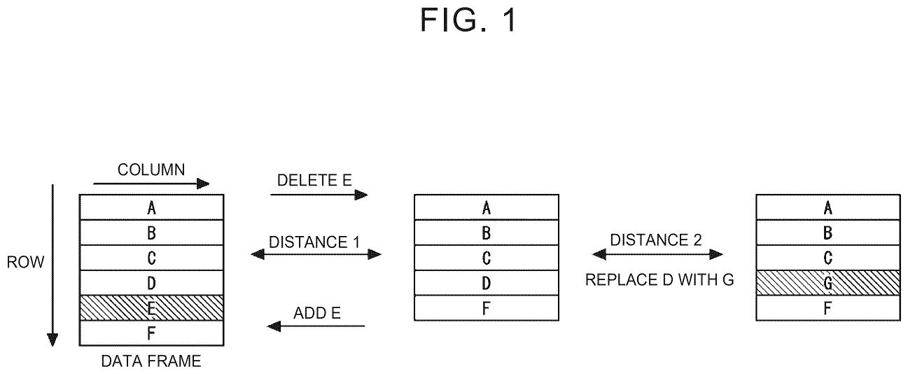

FIG. 1 is a diagram illustrating the definition of a distance function based on the LCS distance. A data frame has a two-dimensional data structure composed of rows and columns. One row corresponds to the data of one individual. Each column may represent an attribute of a corresponding individual (e.g., age). In the LCS distance, addition or deletion of one element (e.g., row E) increases the distance by one. Furthermore, in the LCS distance, replacement of one element (e.g., row D and row G) increases the distance by two. The LCS distance corresponds to the definition of UnboundedDP that considers addition and deletion of one individual and does not consider replacement of one individual.

By defining the distance between data frames using the LCS distance, it becomes possible to define the sensitivity for operations that depend on positions within the data frame. For example, an operation that retrieves the first n elements of a data frame (e.g., df[0:n]) can readily be determined to have a sensitivity of 1, since the distance does not change before and after the operation. In a more non-trivial example, the sensitivity for a stable sort operation on a data frame is determined to be 2.

### Tracking of Data Frame Provenance

Operations between data frames (e.g., element-wise computation, comparison, filtering) are understood as operations that take multiple data frames as input. Since sensitivity is defined for functions in which the inputs and outputs are in a one-to-one correspondence, a new mechanism is introduced to enable the tracking of the sensitivity of operations between data frames.

For example, suppose that an operation on two data frames DF1, DF2 is denoted as DF1, DF2→DF3, and one data frame DF3 is obtained as the output. Let the distance tracked in DF1 be d1 and the distance tracked in DF2 be d2, and suppose that the distance d3 of DF3 is to be determined. The method of determination varies according to the type of operation. Operations between data frames are often row-wise operations (e.g., addition, comparison, filtering). In row-wise operations, the operation is performed on pairs of rows at the same row positions. In the definition of the LCS distance, there is a possibility that the row positions are shifted by one between inputs that are at distance 1 from each other. As a result, the output distance d3 cannot be bounded, and becomes d3=∞. For example, suppose that a value df1 of DF1 is fixed, and consider values df2, df2′ of DF2 that are at distance 1 from each other. The number of rows in df2 differs from that in df2′ by one, and all rows except one are identical between df2 and df2′. However, since the row positions are shifted between df2 and df2′, the value df3 resulting from a row-wise operation on df1 and each of df2 and df2′ may vary by as many as the number of rows in df2 or df2′.

It is not possible to track the distance for general operations between data frames. However, the distance can be tracked for operations between data frames in which the number of rows and the positional relationships of the rows have not changed. By associating data frames in which the row positions are preserved, that is, in which the number of rows and the positional relationships of the rows have not changed, with the same provenance, it becomes possible to determine whether the distance can be tracked. The introduction of this mechanism makes it possible to track the sensitivity of operations that include operations between data frames. The provenance corresponds to the provenance information described above.

In the first embodiment, an implementation as a library on the Python language will be described. It is herein assumed that the pandas library is used as an implementation of data frames. The proposed library that ensures differential privacy is implemented as a wrapper for the pandas library. The proposed library provides an application programming interface (API) similar to that of the pandas library. On the wrapper library side, operations for which sensitivity can be bounded are permitted, and operations for which sensitivity cannot be bounded are prohibited.

A data frame for which differential privacy is to be ensured is loaded as an instance of a special class. In the first embodiment, this special class is defined as the PrivateDataFrame class. A distance is associated with an object of the PrivateDataFrame class. The distance of the PrivateDataFrame class is dynamically tracked. For objects derived from a PrivateDataFrame object before the addition of a perturbation, a special class is also defined, and the distance is tracked dynamically in the same way. For example, a Sensitive Value class is defined for a real number before the addition of a perturbation, and the real number is wrapped. Hereinafter, objects to be kept private before the addition of a perturbation, such as objects of the PrivateDataFrame class or the Sensitive Value class, will be referred to as “private objects.” It is not possible to output the value contained in a private object as is. Instead, it is possible to output a value obtained by adding a perturbation to the value contained in a private object. For example, a Sensitive Value object is converted into a mere real number by applying the Laplace mechanism.

Operations on private objects are defined individually. Based on the sensitivity of each operation, an appropriate distance is set for the private object that is the output of the operation. For example, when the distance of the input private object of an operation having sensitivity c is d, the distance of the output private object is defined as c×d. The library implementer derives an appropriate sensitivity and defines the transition of the distance based on the definition of the LCS distance. An operation that releases a private object adds a perturbation of an appropriate magnitude according to the distance associated with the input private object, and returns a normal, non-private object. In an operation of adding a perturbation, ε is to be specified as a parameter by the library user.

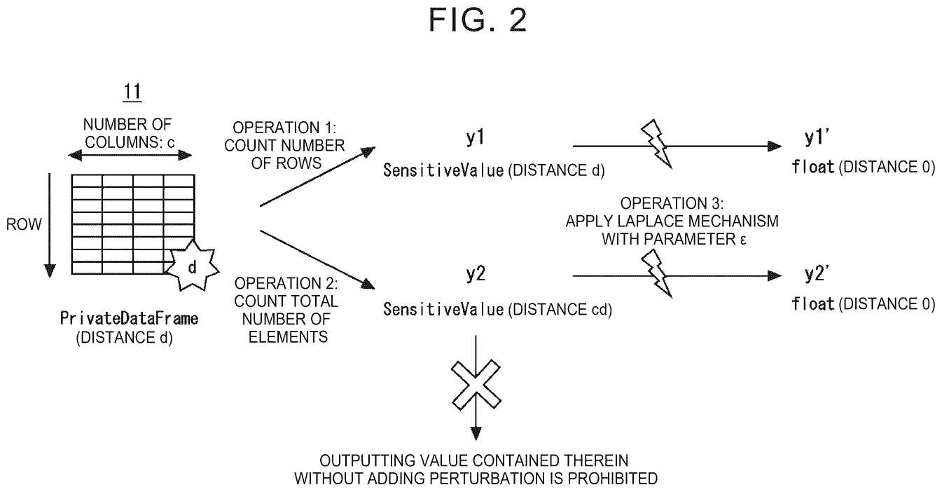

FIG. 2 is a diagram illustrating an example of the transition of the distance between private objects. The distance between data frames is defined by the LCS distance. Accordingly, the distance between data frames increases by one when one row is added or deleted. First, operation 1 will be described. Operation 1 is an operation of obtaining the number of rows of a data frame 11 having a distance d. A real number y1 indicating the number of rows of the data frame 11 has the distance d. That is, the real number y1, namely the output of operation 1, is associated directly with the distance d of the input to operation 1. Next, operation 2 will be described. Operation 2 is an operation of obtaining the total number of elements of the data frame 11. When the number of columns of the data frame 11 is c, a real number y2, namely the output of operation 2, is defined to have a distance of c×d. This is because the number of columns of the data frame 11 is constant regardless of the distance, and when the number of rows changes by one, the total number of elements changes by c. Operations 1, 2 take a PrivateDataFrame object as input and return a Sensitive Value object as output.

In operation 3, the Laplace mechanism with ε as a parameter is applied to the SensitiveValue object, and a perturbation of an appropriate magnitude is added. For example, a perturbation corresponding to the distance d is added to y1, and a row count y1′ that satisfies ε-differential privacy is obtained. Similarly, a perturbation corresponding to the distance cd is added to y2, and a total number of elements y2′ that satisfies ε-differential privacy is obtained. The row count y1′ and the total number of elements y2′ are handled, for example, as float-type values and are associated with distance 0. It is prohibited to output the values contained in the private objects y1, y2 without adding a perturbation to the private objects y1, y2.

In the system described in “Antigranular” [online], [accessed on Dec. 25, 2024], Internet https://www.antigranular.com, there is no function to propagate and track a distance from one private object to another private object. Therefore, it is necessary to add a perturbation each time data is extracted from a data frame, which lacks flexibility. On the other hand, C. Abuah, A. Silence, D. Darais, and J. P. Near, “DDUO: General-Purpose Dynamic Analysis for Differential Privacy,” 2021 IEEE 34th Computer Security Foundations Symposium (CSF), Dubrovnik, Croatia, 2021, cannot track the distance of operations between data frames, and thus lacks practicality.

In order to enable operations between data frames, the first embodiment tracks, in addition to the distance, a provenance for determining whether the row positions are to be preserved. An operation that preserves row positions is also referred to as an operation that preserves rows. All of the following conditions need to be satisfied in order for the rows to be preserved between a PrivateDataFrame object obtained as an output of a certain operation and one or more PrivateDataFrames input to that operation.
When multiple PrivateDataFrames are input, all of the PrivateDataFrames have been obtained by applying exclusively operations that preserve rows to a certain PrivateDataFrame.
The result of a computation on the ith row of the input PrivateDataFrame is located at the ith row of the output PrivateDataFrame.
In performing a computation on the ith row of the input PrivateDataFrame, values of rows other than the ith row are not used.
In performing a computation on the ith row of the input PrivateDataFrame, the value of the row number i is not used.

In an operation that preserves rows, the number of rows of the PrivateDataFrame and the correspondence of the rows do not change. Similarly, in an operation that preserves rows, the distance is also preserved between the input and the output.

Although an operation on two PrivateDataFrames will be specifically described, the same applies to an operation on three or more PrivateDataFrames. In an operation that preserves rows such as row-wise addition, the provenance of the PrivateDataFrame object is preserved between the input and the output. On the other hand, in an operation such as filtering rows or rearranging rows (e.g., sorting), the number of rows and the correspondence of the rows may change. In an operation that does not preserve rows, the provenance is not preserved between the input and the output. A PrivateDataFrame object that is the output of an operation that does not preserve rows is associated with a new provenance. The new provenance is a unique provenance (e.g., ID) that does not duplicate any provenance used thus far.

Even in an operation that does not preserve rows, the above conditions may be satisfied for a specific input. However, the output of an operation that does not preserve rows is to be associated with a new provenance. This is because, depending on whether the provenance is new, there is a risk of leaking information about an operation that is to be kept private. For example, if it is found that the number of rows has changed as a result of filtering, it would be revealed, without the addition of a perturbation, that there existed a row(s) meeting the filtering condition.

The provenance associated with a PrivateDataFrame is referenced in row-wise operations between data frames, and row-wise operations are permitted exclusively between data frames associated with the same provenance. That is, row-wise operations between data frames associated with different provenances cause an error. Even when rows are preserved in an operation between data frames, the output of the operation is associated with the same provenance as that associated with the input of the operation.

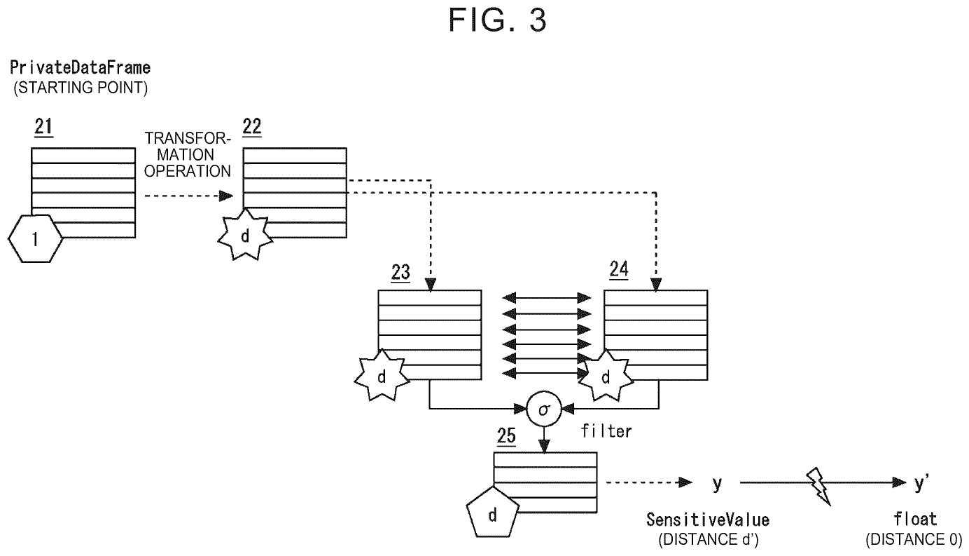

FIG. 3 is a diagram illustrating an example of operations on PrivateDataFrames. The starting point is a data frame 21 that is an adjacent data frame at distance 1. The hexagonal mark shown at the lower left of the data frame 21 represents the provenance of the data frame 21. When an operation that does not preserve rows is applied to the data frame 21, a data frame 22 is obtained. The distance of the data frame 22 is d. The data frame 22 is associated with a provenance different from the provenance associated with the data frame 21.

An operation that preserves rows is applied to the data frame 22. As a result, a data frame 23 is obtained. The distance of the data frame 23 is d, and the data frame 23 is associated with the same provenance as that associated with the data frame 22. Similarly, another operation that preserves rows is applied to the data frame 22. As a result, a data frame 24 is obtained. The distance of the data frame 24 is d, and the data frame 24 is associated with the same provenance as that associated with the data frame 22.

Row-wise operations are permitted between the data frame 23 and the data frame 24 that are associated with the same provenance. For example, a filtering operation σ is applied to the data frames 23, 24. As a result, a data frame 25 is obtained. The filtering operation σ is not an operation that preserves rows. The distance of the data frame 25 is d, and the data frame 25 is associated with a provenance different from the provenance associated with the data frames 23, 24.

Subsequently, an operation is applied to the data frame 25. As a result, a Sensitive Value object y having a distance d′ is obtained. A perturbation corresponding to the distance d′ is added to the SensitiveValue object y using, for example, the Laplace mechanism. As a result, a real number y′ that satisfies e-differential privacy is obtained.

The first embodiment can track the sensitivity for operations on ordered data frames.

In the present disclosure, part or all of the processing of the computer can be implemented by causing a central processing unit (CPU) to execute a computer program.

The above-described program includes a set of instructions (or software code) that, when loaded into a computer, causes the computer to perform one or more functions described in the embodiment. The program may be stored in a non-transitory computer-readable medium or a tangible storage medium. Examples of the computer-readable medium or the tangible storage medium include, but are not limited to, random-access memory (RAM), read-only memory (ROM), flash memory, solid-state drives (SSDs), and other memory technologies; compact disc read-only memories (CD-ROMs), digital versatile discs (DVDs), Blu-ray (trademark) discs, and other optical disc storage; and magnetic cassettes, magnetic tapes, magnetic disk storage, and other magnetic storage devices. The program may be transmitted over a transitory computer-readable medium or a communication medium. Examples of the transitory computer-readable medium or the communication media include, but are not limited to, propagated signals in electrical, optical, acoustic, or other forms.

Although the present disclosure has been described with reference to the embodiments, the present disclosure is not limited thereto. Various modifications that would be understood by a person skilled in the art can be made to the configuration and details of the present disclosure without departing from the scope of the present disclosure. Each embodiment may be combined with other embodiments as appropriate.

What is claimed is:

1. A method for tracking sensitivity in differential privacy, the method comprising:
when a condition is satisfied that each row of a second data frame obtained by applying an operation to one or more first data frames associated with the same first provenance information represents a result of a computation on a corresponding row of the one or more first data frames and the number of rows of the one or more first data frames is the same as the number of rows of the second data frame, associating the second data frame with the first provenance information; and when the condition is not satisfied, associating the second data frame with second provenance information different from the first provenance information; and
tracking the sensitivity based on an edit distance related to the operation.

2. The method according to claim 1, wherein the edit distance is a longest common subsequence distance.

3. The method according to claim 1, wherein, when the operation includes filtering or sorting, the second data frame is associated with the second provenance information.

4. A non-transitory storage medium storing a program that causes a computer to
when a condition is satisfied that each row of a second data frame obtained by applying an operation to one or more first data frames associated with the same first provenance information represents a result of a computation on a corresponding row of the one or more first data frames and the number of rows of the one or more first data frames is the same as the number of rows of the second data frame, associate the second data frame with the first provenance information, and when the condition is not satisfied, associate the second data frame with second provenance information different from the first provenance information, and
track sensitivity based on an edit distance related to the operation.

5. A computer configured to
when a condition is satisfied that each row of a second data frame obtained by applying an operation to one or more first data frames associated with the same first provenance information represents a result of a computation on a corresponding row of the one or more first data frames and the number of rows of the one or more first data frames is the same as the number of rows of the second data frame, associate the second data frame with the first provenance information, and when the condition is not satisfied, associate the second data frame with second provenance information different from the first provenance information, and
track sensitivity based on an edit distance related to the operation.
